(19) United States
(12) Patent Application Publication
(10) Pub. No.: US 2004/0205989 A1
(43) Pub. Date: Oct. 21, 2004

(54) Bottle labeling system and method of using same

(76) Inventor: Kimberly Michaels, Ithaca, NY (US)

Correspondence Address: BROWN & MICHAELS, PC, 400 M & T BANK BUILDING, 118 NORTH TIOGA ST, ITHACA, NY, 14850, US

(21) Appl. No.: 10/419,601

(22) Filed: Apr. 21, 2003

(51) Int. Cl. G09F 3/00; G09F 3/14

(52) U.S. Cl. 40/310; 40/665

(57) ABSTRACT

The labeling device of the present invention includes a set of elastic bands. The elastic bands include an indicator, which identifies at least one characteristic relating to contents within a baby bottle. In one embodiment, the indicator is color-coding of the elastic bands. In another embodiment, the indicator is a day of the week printed on each elastic band. In a preferred embodiment, multiple indicators are used. For example, the elastic bands are both color-coded and have the days of the week printed on them. In this embodiment, each color preferably corresponds to a printed day of the week. The elastic bands are sized to fit snugly around baby bottles.

### BACKGROUND OF THE INVENTION

1. Field of the Invention

The invention pertains to the field of labeling. More particularly, the invention pertains to a labeling system for baby bottles.

2. Description of Related Art

Breast milk and formula have a limited shelf life. In order to keep track of how fresh the milk or formula is, labeling is important. Much like rotating produce or other perishable items in stores or restaurants, mothers, child-care providers and day-care centers use milk or formula from the earliest date first. Keeping track of multiple bottles pumped, thawed, or mixed on different days is critical.

Labeling bottles with stickers, labels or tape leaves a gum-residue on the bottles. Labeling bottles with permanent markers is not practical for multiple uses. Non-permanent markers rub off. Furthermore, labels do not stick well, and marker does not write well on bottles which are cold or have condensation on the outside.

Therefore, there is a need in the art for a simple, inexpensive, reusable labeling system for baby bottles.

### SUMMARY OF THE INVENTION

The labeling device of the present invention includes a set of elastic bands. The elastic bands include an indicator, which identifies at least one characteristic relating to contents within a baby bottle. In one embodiment, the indicator is color-coding of the elastic bands. In another embodiment, the indicator is a day of the week printed on each elastic band. In a preferred embodiment, multiple indicators are used. For example, the elastic bands are both color-coded and have the days of the week printed on them. In this embodiment, each color preferably corresponds to a printed day of the week. The elastic bands are sized to fit snugly around baby bottles.

### BRIEF DESCRIPTION OF THE DRAWINGS

FIG. 1 shows an embodiment of the present invention, where the set of elastic bands is both color-coded and includes the days of the week printed on them.

FIG. 2 shows an example of the labeling device of the present invention on a baby bottle.

FIG. 3A shows an embodiment of the present invention, where the set of elastic bands has either “frozen” or “fresh” printed on them.

FIG. 3B shows an embodiment of the present invention, where the set of elastic bands has either “breast milk” or “formula” printed on them.

FIG. 3C shows an embodiment of the present invention, where the set of elastic bands is numbered.

### DETAILED DESCRIPTION OF THE INVENTION

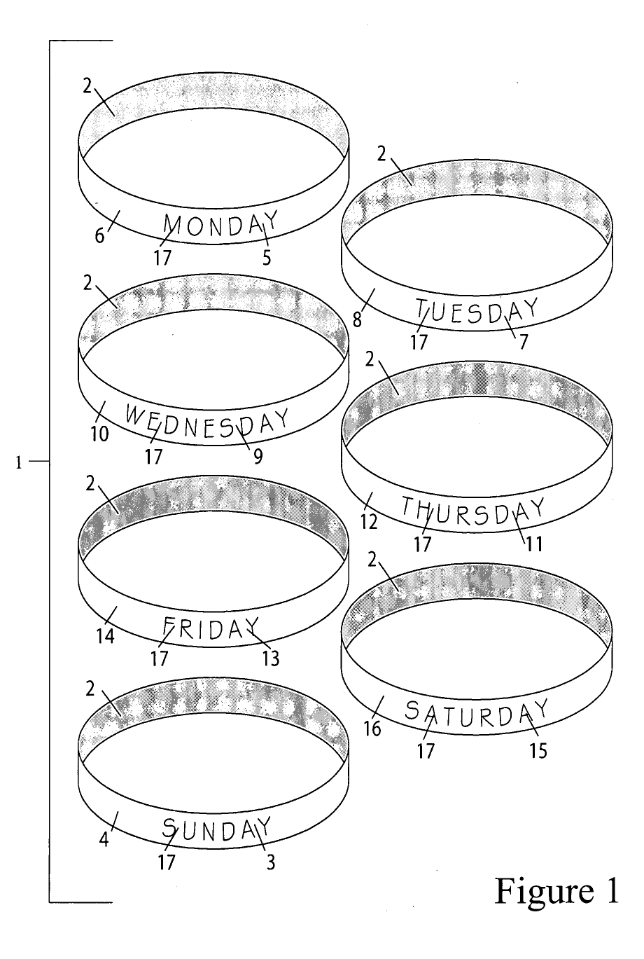

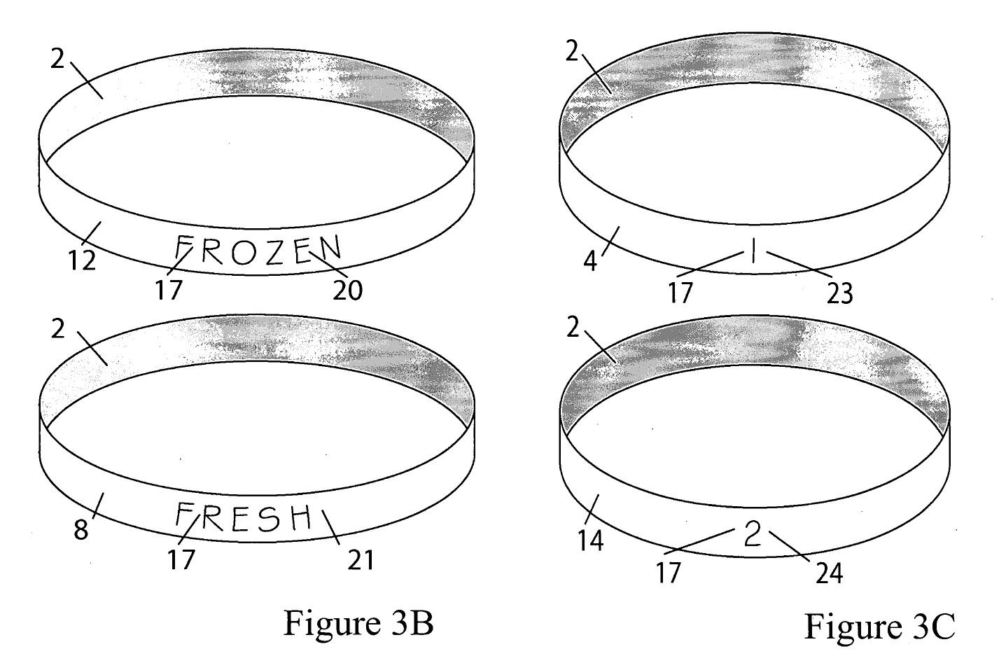

Referring now to FIGS. 1, 2, 3A and 3B, the labeling device of the present invention includes a set (1) of elastic bands (2). The elastic bands (2) include an indicator. The indicator identifies at least one characteristic relating to contents within a baby bottle (22). The indicator in one embodiment is color-coding. In a preferred embodiment, each color identifies a day of the week. For example, red (6) identifies “Monday” bands, and orange (8) identifies “Tuesday” bands. Alternatively, color-coding is used to distinguish breast milk (red (6)) from formula (yellow (10)), as shown in FIG. 3A. In yet another example, color-coding is used to distinguish whether the contents are fresh (green (12)) or frozen (orange (8)), as shown in FIG. 3B. The color of the elastic bands also could indicate the brand or type of formula of the contents. The color-coding is preferably tailored to the needs of the user. All of the specific colors listed throughout this application are examples only, and any colors can be substituted for those listed here.

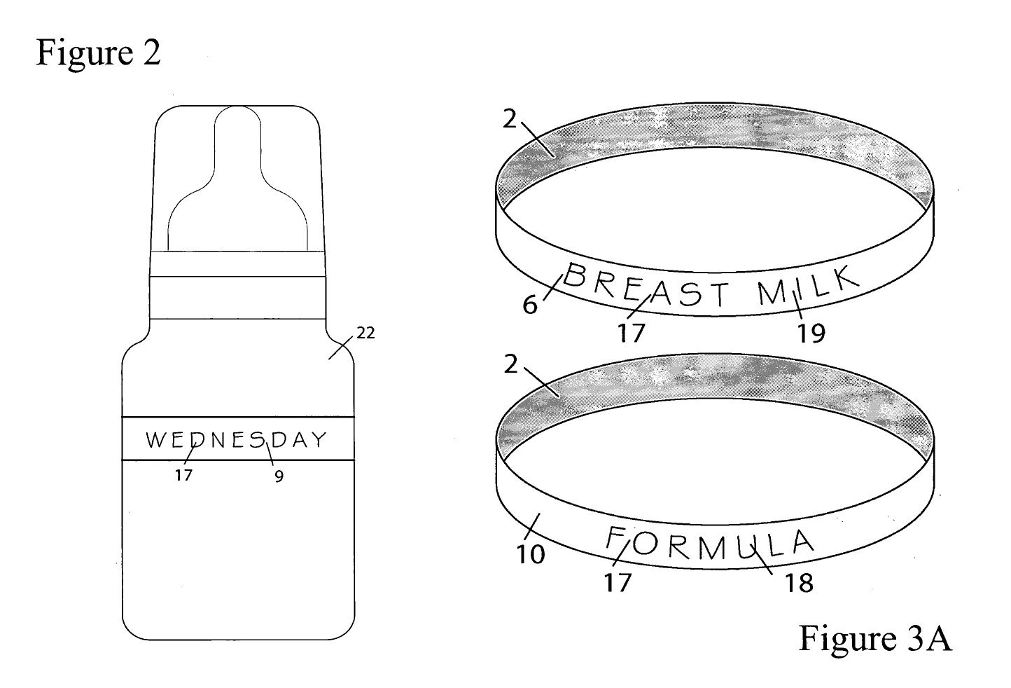

In another embodiment, the indicator is a written indicator printed (17) on the elastic bands. For example, the days of the week are printed on the elastic bands in FIGS. 1 and 2. In other embodiments, the written indicator (17) is “mixed by Date”, “thawed on date”, “use by date”, “use on or before date”, or “pumped on date”. In these embodiments, the “date” is a day of the week.

In an alternative embodiment, “formula” (18) or “breast milk” (19) is printed on the bands in FIG. 3A so that the user knows what the contents of a particular bottle are. In yet another embodiment, “frozen” (20) or “fresh” (21) is printed on the elastic bands (2).

In a preferred embodiment, the elastic bands are both color-coded and have the days of the week printed on them (see FIG. 1). The elastic bands are alternatively color-coded to indicate the days of the week, but printed with another indicator, for example, “frozen” or fresh”, or vice versa (see FIG. 3B). By combining color-coding with printed labeling in this manner, each elastic band tells the user two independent pieces of information, in this example whether the contents are frozen or fresh, and a day of the week applicable to the contents. Although the Figs. show both a written indicator (17) and color-coding on each elastic band, either of the indicators alone is also within the scope of the present invention.

The elastic bands (2) have a size to fit snugly around bottles (22). Since baby bottle diameters preferably range from 2.25 to 2.5 inches in diamater, the elastic bands (2) are preferably of a size to fit this range. However, elastic bands (2) of any size to fit any bottle on the market are within the scope of the present invention. The elastic bands (2) are preferably made of a latex-free band material, including, but not limited to, polysioprene. This material allows them to be resilient and reusable.

Mothers and child-care providers save time with the labeling system of the present invention, because it does not involve writing. By fitting a color-coded elastic band pre-printed with the day of the week on a bottle, one is able to label the day breast milk was pumped or thawed, or the day that formula was mixed or opened, quickly and easily. Bands could alternatively be used to label the last date of freshness, or “use by” day. A chart of the generally accepted amount of time breast milk and formula stays fresh is shown in Table 1.

TABLE 1

| | | | | Deep |
|---|---|---|---|---|
| | | | Home | Freeze |
| | Room Temp. | Refrigerator | Freezer | (−20 F.) |
| Freshly | @ 66-72° F.: | @ 32-39° F.: | 6 months | 12 months |
| Expressed | up to 10 hours | 8 days | | |
| Breast Milk | @ 79° F.: 4-6 | | | |
| | hours | | | |
| Thawed Breast | Do not store @ | 24 hours | Do not re- | Do not re- |
| Milk | room temp. | | freeze | freeze |
| | Use within 4 | | | |
| | hours after | | | |
| | warming | | | |
| Formula | Do not store @ | 48 hours | Do not | Do not |
| | room temp. | | freeze | freeze |
| | Use within 1 | | | |
| | hour after | | | |
| | warming. | | | |

In a method of the present invention, an elastic band (2) is stretched over a bottle (22) and allowed to constrict around it, serving as a label. The band (2) preferably includes the day of the week in writing, is color-coded, or both. An example of elastic bands (2) which contain writing and are color coded to indicate the days of the week is shown in FIG. 1 and Table 2. The device is flexible, since the elastic bands (2) can either be used to denote the day mixed or pumped, thawed or frozen, or use by date.

TABLE 2

| DAY OF THE WEEK | COLOR OF |
|---|---|
| (IN WRITING) | ELASTIC BAND |
| SUNDAY (3) | Brown (4) |
| MONDAY (5) | Red (6) |
| TUESDAY (7) | Orange (8) |
| WEDNESDAY (9) | Yellow (10) |
| THURSDAY (11) | Green (12) |
| FRIDAY (13) | Blue (14) |
| SATURDAY (15) | Purple (16) |

As an example of the method, after preparing baby's bottles (22) of breast milk or formula, a mother or another user slips an elastic band (2) around each bottle (22) to note the day the bottle was prepared. Alternatively, the mother uses the bands to note the day by which the bottle should be used. The band is removed from the bottle before boiling or running bottles through the dishwasher. If necessary, the bands are rinsed in hot, soapy water. Bands are reusable, and can be put in the refrigerator or the freezer.

Referring now to FIG. 3C, in an alternative embodiment, daycare centers or other childcare providers can use the bands (2) to indicate how many times a bottle has been offered to a child. Common daycare policy allows use of bottles only 2 or 3 times before disposing of the remaining breast milk or formula. Bands with a written indicator (17) of a number (23) or (24) could be used to indicate how many times a bottle has been offered to the child to help daycare providers. In the example shown in FIG. 3C, the bands are both color-coded (4) and (14) and numbered 1 (23) and 2 (24). However, bands (2) that are all the same color could also be numbered in this manner. An alternate embodiment of this idea is to use bands that are not labeled. In this embodiment, putting on one band, with no particular color or label, for each time a bottle is offered to a child provide the user with the required information.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A labeling system for baby bottles, comprising a plurality of elastic bands, sized to fit snugly on a baby bottle wherein each elastic band comprises an indicator for identifying at least one characteristic relating to contents within the baby bottle.

2. The labeling system of claim 1, wherein the indicator comprises a color of each elastic band.

3. The labeling system of claim 2, wherein each color indicates a different day of the week.

4. The labeling system of claim 1, wherein the indicator on each elastic band comprises a written indicator.

5. The labeling system of claim 4, wherein the written indicator indicates a day of the week.

6. The labeling system of claim 1, wherein the characteristic being identified comprises a day of the week.

7. A method of labeling a baby bottle comprising the steps of:
a) choosing at least one elastic band sized to fit snugly on the baby bottle wherein each elastic band comprises an indicator for identifying at least one characteristic relating to contents within the baby bottle; and
b) fitting the elastic band on the baby bottle.

8. The method of claim 7, further comprising the step of repeating steps a) and b) for a plurality of bottles using a plurality of elastic bands.

9. The method of claim 8, further comprising the step of storing each of the baby bottles with elastic bands in a refrigerator or a freezer and selecting the baby bottle for use based upon the indicator on the elastic band.

10. The method of claim 7, wherein the indicator comprises a color of each elastic band.

11. The method of claim 10, wherein each color indicates a different day of the week.

12. The method of claim 7, wherein the indicator on each elastic band comprises a written indicator.

13. The method of claim 12, wherein the written indicator indicates a day of the week.

14. The method of claim 7, wherein the indicator identifies a day of the week selected from the group consisting of:
a) the day formula inside the bottle was mixed;
b) the day formula inside the bottle was opened;
c) the day breast milk inside the bottle was pumped;
d) the day breast milk inside the bottle was thawed;
e) the day breast milk inside the bottle was frozen;
f) the use by date of breast milk; and
g) the use by date of formula.

15. In combination, a baby bottle and an elastic band sized to fit snugly on the baby bottle wherein the elastic band comprises an indicator for identifying at least one characteristic relating to contents within the baby bottle.

16. The combination of claim 15, wherein the indicator comprises a color of each elastic band.

17. The combination of claim 16, wherein each color indicates a different day of the week.

18. The combination of claim 15, wherein the indicia on each elastic band comprises a written indicia.

19. The combination of claim 18, wherein the written indicia indicates a different day of the week.

20. The combination of claim 15 wherein the indicia indicates a different day of the week.
